(19) United States
(12) Patent Application Publication
(10) Pub. No.: US 2008/0141327 A1
(43) Pub. Date: Jun. 12, 2008

(54) APPARATUS AND METHOD FOR CONFIGURING AND EXECUTING FUNCTION OF APPLICATION APPROPRIATE TO BROADCAST-RECEIVING DEVICE

(75) Inventors: Keum-yong Oh, Yongin-si (KR); Kwang-hyun Koh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/872,119

(22) Filed: Oct. 15, 2007

(30) Foreign Application Priority Data
Dec. 8, 2006 (KR) 10-2006-0124838

(51) Int. Cl. H04N 7/173

(52) U.S. Cl. 725/131

(57) ABSTRACT

An apparatus and method for configuring and executing an application appropriate to a broadcast-receiving device are provided. The apparatus includes an application-generating unit that generates an application having at least two functions to be selectively performed by the broadcast-receiving device and information related with the application, and an application-transmitting unit that transmits the generated application and the information related with the application to the broadcast-receiving device via a predetermined communication method, wherein the application determines which function is activated among the at least two functions, and provides the determined result to the broadcast-receiving device.

### CROSS-REFERENCE TO RELATED APPLICATION

This application is based on and claims priority from Korean Patent Application No. 10-2006-0124838 filed on Dec. 8, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to data broadcasting technologies, and more particularly to configuring and executing the function of an application appropriate to a broadcast-receiving device.

2. Description of the Related Art

Data broadcasting transmits information using a code format or a data format instead of a sound format or an image format via a broadcast network such as a terrestrial wave network, a cable network, or a satellite network, which provides the information of a broadcast program, e.g., life information, Internet connection, electronic commerce services, and bidirectional entertainment.

The data-broadcasting standards that define elements needed to provide data-broadcasting services are handled by several organizations and groups based on the types of content, formats and processing environment of applications, and the application-transmitting method. International data-broadcasting standards include the open cable application platform (OCAP), the advanced common application platform (ACAP), and the multimedia home platform (MHP).

The ACAP standardization is detailed in ATSC T3/S2, which was promulgated after a memorandum of understanding was signed in November, 2002 for a common standardization between ATSC and CableLabs. The MHP standard is a data-broadcast middleware standard selected for Europe by the European Telecommunications Standards Institute (ETSI). MHP 1.0 is to process Java-based content, and MHP 1.1 adds a bidirectional service and a function to process markup language-based content. OCAP is a data broadcast middleware standard selected by the society of cable television engineers (SCTE), which is an organization for North American cable broadcast businesses. OCAP 1.0, which is based on MHP 1.0, was approved as a cable data broadcast standard by SCTE in February, 2002.

Data broadcasting, such as the OCAP, ACAP, and MHP, enables reception and execution applications using broadcast signals. The development of data broadcasting enables the provision of an application having various functions to a variety of broadcast-receiving devices. For example, various network functions and recording functions will be installed in broadcast-receiving devices through new communication standards, and also mobile devices will exist in broadcast networks. The devices in the broadcast communication network will have a data-broadcast-receiving module, and therefore it is required that a single application selectively executes a functional element, which is appropriate to each property of several broadcast-receiving devices, of the application.

FIG. 1 depicts the transmission of a single application to a broadcast-receiving device according to related art.

Referring to FIG. 1, a data-broadcast-transmitting device 10 generates an application, and transmits the application to a data-broadcast-receiving device 20. The application refers to a program executed based on the Java virtual machine (JVM) in the data-broadcast-receiving device. The application is transmitted by the data-broadcast-transmitting device 10, and loaded and processed by the data-broadcast-receiving device 20. A user can receive information related with media data by providing a broadcast including applications as well as A/V data.

Generally, an application having one purpose is produced on the condition that a broadcast-receiving device has a large display, and is transmitted. Accordingly, an application appropriate to another type of broadcast-receiving device, e.g., a small mobile device, has not been provided. There is a problem in that it is difficult to selectively execute several functions of the transmitted application to fit properties of the broadcast-receiving device.

### SUMMARY OF THE INVENTION

In view of the above, it is an aspect of the present invention to provide a broadcast-receiving device that discloses an application transmitted using information related to the application, and provides information on the broadcast-receiving device when executing the application, and therefore the application can select which functional element is activated or not activated among several functional elements that the application has.

This and other aspects of the present invention will become clear to those skilled in the art upon review of the following description, attached drawings and appended claims.

According to an aspect of the present invention, there is provided an apparatus for configuring the function of an application appropriate to a broadcast-receiving device, the apparatus including an application-generating unit that generates an application having at least two functions to be selectively performed by the broadcast-receiving device and information related with the application, and an application-transmitting unit that transmits the generated application and the information related with the application to the broadcast-receiving device via a predetermined communication method, wherein the application determines which function is activated among the at least two functions, and provides the determining result to the broadcast-receiving device.

According to another aspect of the present invention, there is provided an apparatus for executing the function of an application appropriate to a broadcast-receiving device, the apparatus including an application-analyzing unit that receives and analyzes an application and information related with the application using a predetermined communication method, a functional-element-defining unit that defines a functional element including each of at least two functions of the application based on the analysis, a function-selecting unit that selects one or more functions among the two or more functions, and an executing unit that executes the selected function.

According to still another aspect of the present invention, there is provided a method of configuring the function of an application appropriate to a broadcast-receiving device, the method including generating an application having at least two functions to be selectively performed by the broadcast-receiving device and information related with the application, and transmitting the generated application and the information related with the application to the broadcast-receiving device via a predetermined communication method, wherein the application determines which function is activated among the at least two functions, and provides the determined result to the broadcast-receiving device.

According to another aspect of the present invention, there is provided a method for executing the function of an application appropriate to a broadcast-receiving device, the method including receiving and analyzing an application and information related with the application using a predetermined communication method, defining a functional element included each of at least two functions of the application based on the analysis, selecting one or more functions among the two or more functions, and executing the selected function.

### BRIEF DESCRIPTION OF THE DRAWINGS

The above and other features and advantages of the present invention will become apparent by describing in detail exemplary embodiments thereof with reference to the attached drawings in which:

FIG. 1 depicts the transmission of a single application to a broadcast-receiving device according to the related art;

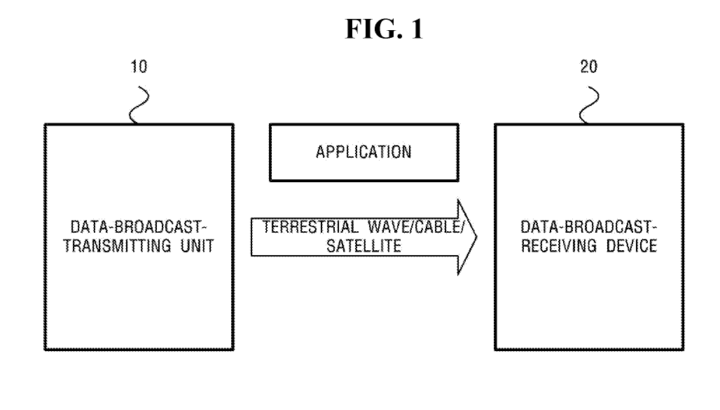

FIG. 2 depicts the transmission of a single application appropriate to a plurality of broadcast-receiving devices by a broadcast-receiving device according to an exemplary embodiment of the present invention;

FIG. 3 is a block diagram showing an apparatus for configuring the function of an application according to an exemplary embodiment of the present invention;

FIG. 4 depicts carousel information received by a broadcast-receiving device according to an exemplary embodiment of the present invention;

FIG. 5 is a block diagram showing an apparatus for executing the function of an application according to an exemplary embodiment of the present invention;

FIG. 6 depicts a process of selecting the function of an application appropriate to a broadcast-receiving device according to an exemplary embodiment of the present invention;

FIG. 7 depicts a process of executing an application by comparing component tag information and association tag information;

FIG. 8 is a flow chart of a method of configuring the function of an application appropriate to a broadcast-receiving device according to an exemplary embodiment of the present invention;

FIG. 9 is a flow chart of a method of executing the function of an application appropriate to a broadcast-receiving device according to an exemplary embodiment of the present invention.

### DETAILED DESCRIPTION OF THE INVENTION

Exemplary embodiments of the present invention will be described in detail with reference to the accompanying drawings.

Advantages and features of the present invention and methods of accomplishing the same may be understood more readily by reference to the following detailed description of the exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

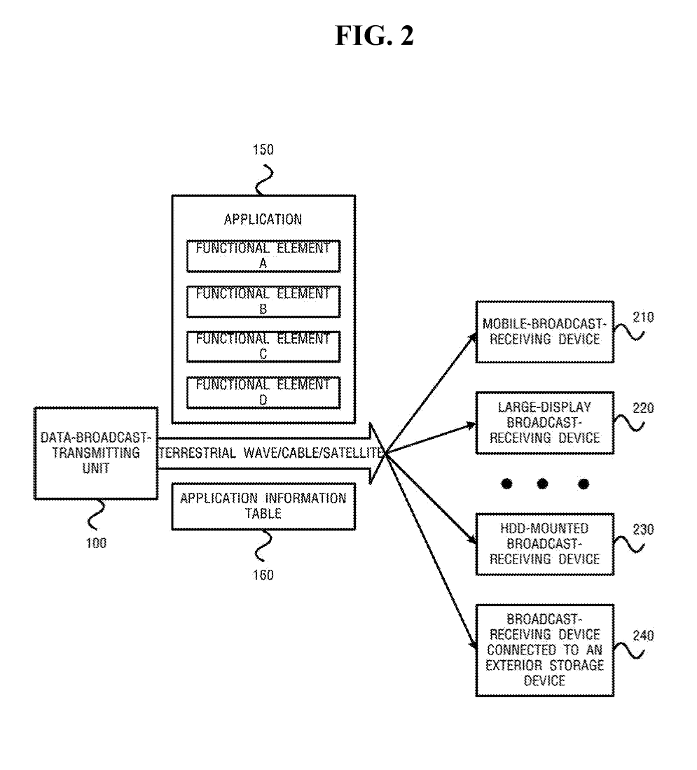

FIG. 2 depicts the transmission of a single application appropriate to a plurality of broadcast-receiving devices by a broadcast-receiving device according to an exemplary embodiment of the present invention.

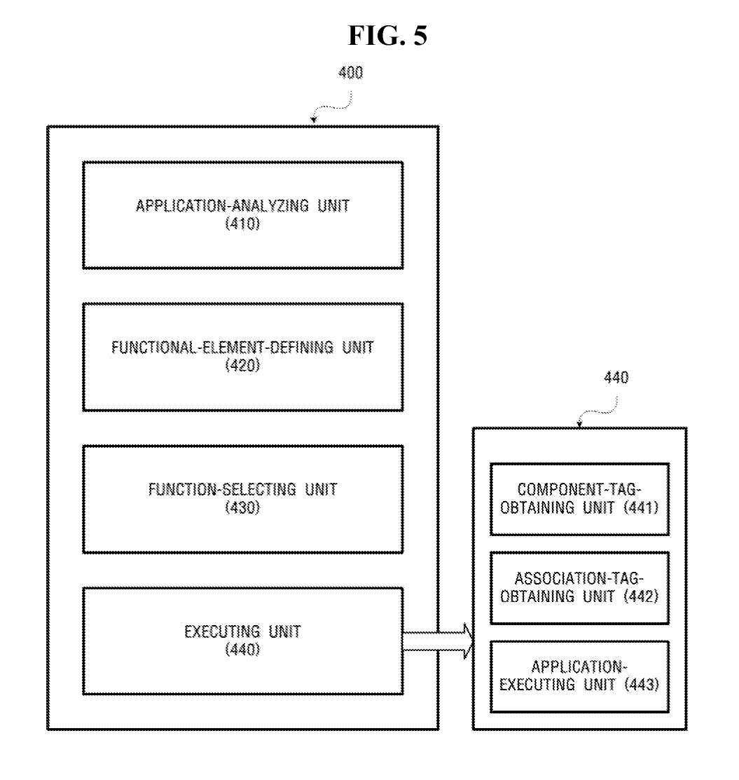

Referring to FIG. 2, a data-broadcasting apparatus 100 generates an application 150 having a plurality of functional elements according to types and properties of a broadcast-receiving device. In the present invention, the application 150 is produced to be executed for a special purpose in a receiving terminal using different multimedia data. The application 150 has different functional elements, which are selectively activated by referring to a functional element definition of the broadcast-receiving device. This mechanism will be described with reference to FIG. 5. The number of functional elements included in the transmitted application 150 is not limited to a specific number. However, for convenience it is assumed that the application has four functional elements in FIG. 2. Also, the application has a plurality of functional elements for providing sports broadcast.

A functional element A basically provides a sports game with additional information such as information on a football player and game progress. A functional element B provides a sports game broadcast of a football game shot from another angle via another channel. Here, the channel may be the same frequency channel or another logical channel if a plurality of logical channels is included in a physical channel, like in multi-mode service (MMS) broadcasting. A functional element C enables recording and providing of a football game broadcast. A functional element D provides the same function as functional element A, and further provides a graphical user interface (GUI) for a small screen.

The application 150 having a plurality of functions can be transmitted via a terrestrial wave, cable, or satellite. The information on the application 150 is included in an application information table 160, and is transmitted.

The broadcast-receiving device receiving the application 150 and the application information table 160 can have various properties and functions, e.g., a mobile-broadcast-receiving device 210 that provides the received broadcast via a small screen, a large-display-broadcast-receiving device 220 that provides the received broadcast via a 50″ large screen, an HDD-mounted broadcast-receiving device 230, and a broadcast-receiving device 240 connected to an exterior storage device.

Even if an application having the functional elements A, B, C, and D is transmitted to the broadcast-receiving device via a predetermined broadcast channel, the functional elements may be smoothly executed, or it may be difficult to execute them according to the property of the broadcast-receiving device. Accordingly, each broadcast-receiving device defines functional elements appropriate to execution in an environment where one application having several functional elements is transmitted. The application 150 determines which functional element is activated or not activated among several elements the application has by referring to the definition of the functional element.

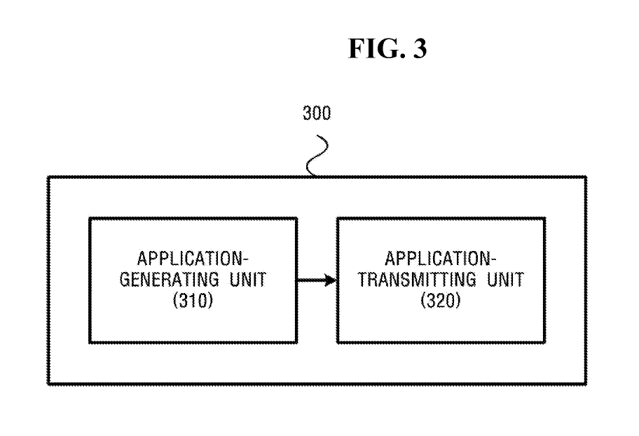

FIG. 3 is a block diagram showing an apparatus for configuring the function of an application according to an exemplary embodiment of the present invention.

Referring to FIG. 3, an application-configuring apparatus 300 generates an application, and transmits it to a receiver. The application conforming apparatus 300 may be embodied as data-broadcast-transmitting equipment. The application-configuring apparatus 300 includes an application-generating unit 310 and an application-transmitting unit 320.

The application-generating unit 310 generates an application having at least two functions to be selectively performed by the broadcast-receiving device and information related to the application.

The application-transmitting unit 320 transmits the generated application and the information related with the application to the broadcast-receiving device via a predetermined communication method. The predetermined communication method can include data broadcast standards provided by the open cable application platform (OCAP), the advanced common application platform (ACAP), or the multimedia home platform (MHP), for example.

The application-configuring apparatus 300 can include an application server (not shown in FIG. 3) that stores content included in the application and information on the application, and controls the application-generating unit 310 and the application-transmitting unit 320.

The application transmitted by the application-transmitting unit 320 determines which functional element is activated or not activated among several elements the application has by referring to the definition of the functional element, and provides the determined result to the broadcast-receiving device, which will be described with reference to FIG. 5.

The information on the application is recorded in an application information table (hereinafter, referred to as “AIT”) or an extended application information table (hereinafter, referred to as “XAIT”), and is transmitted to the broadcast-receiving device. The AIT or XAIT includes information on the broadcast-receiving device in which the application can be executed, total information on a broadcasting service, and information on the transmitted application.

The information on the broadcast-receiving device can include at least one of identification information or version information of the broadcast-receiving device. That is, the AIT can be configured with information on the application corresponding to the mobile-broadcast-receiving device, the large-display broadcast-receiving device, the HDD-mounted broadcast-receiving device, and the broadcast-receiving device connected to an exterior storage device. To execute an application having a picture in picture (PIP) functional element, the broadcast-receiving device should support the PIP function. Therefore, the information on the broadcast-receiving device that can support the PIP function should be recorded in the AIT or the XAIT.

The information on the application can be defined based on the functional element that the broadcast-receiving device can execute. That is, the AIT can be configured with information on the applications corresponding to the functional element A, B, C, and D.

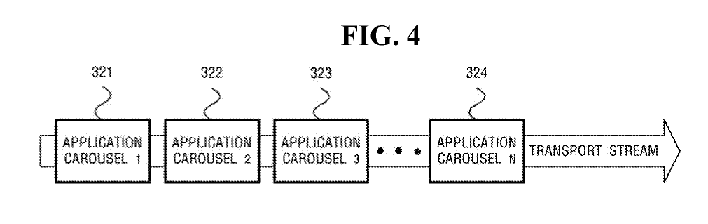

FIG. 4 depicts carousel information received by a broadcast-receiving device according to an exemplary embodiment of the present invention.

The application-transmitting unit 320 in FIG. 3 generates an application in which functional elements are executed by the broadcast-receiving device and a transport stream for transmitting information on the application, which can transmit the transport stream using a carousel method appropriate to the broadcasting.

For example, the application-transmitting unit 320 generates an application having a plurality of functional elements and information on the application as an MPEG-2 transport stream format. The MPEG-2 transport stream may include data for the broadcasting service. At this time, a transmitting/receiving system of the MPEG-2 transport stream is defined in ISO/IEC 13818-1. The data is provided as an independent elementary stream. A transport stream is generated by multiplexing one or more elementary streams. One or more transport streams can be multiplexed, which is referred to as a multiplexed transport stream.

System information (SI) is transmitted in order to distinguish each transport stream from the multiplexed transport stream. It is possible to distinguish each transport stream corresponding to virtual channels using the SI that notifies which program is broadcasted to each channel. Program specific information (PSI) that enables each elementary stream to be distinguished is provided to the virtual channels. The transmitting method is different according to a relation between elementary streams in the multiplexed transport stream, which will be shown as various formats of data-broadcasting services.

The application-transmitting unit 320 transforms the MPEG-2 transport stream into object carousel, data carousel, and MPEG-2 digital storage media command and control (DSM-CC) message format in consecutive order, and finally broadcasts DSM-CC message.

DSM-CC, which is defined by ISO/IEC 13818-6, refers to a message format of a transmitting layer for a data service. ISO/IEC 13818-6, which is the standard technology of MPEG, refers to a technology for the carousel structure and a transmitting method. The data carousel is a mechanism for periodically transmitting a data module according to DSM-CC user-to-network download protocol. The object carousel is a mechanism for periodically transmitting a DSM-CC user-to-user object on the data carousel, which transports the layer-file structure using DSM-CC U-U file/directory object. This process is conceptually depicted in FIG. 4, which shows the transport of application carousels 1, 2, 3, . . . , N(321, 322, 323, and 324).

FIG. 5 is a block diagram showing an apparatus for executing the function of an application according to an exemplary embodiment of the present invention.

Referring to FIG. 5, an application-executing apparatus 400 includes an application-analyzing unit 410, a functional-element-defining unit 420, a function-selecting unit 430, and an executing unit 440.

The application-analyzing unit 410 receives an application and information on the application using a predetermined communication method, and analyzes them. The predetermined communication method can include data broadcast standards provided by the open cable application platform (OCAP), the advanced common application platform (ACAP), or the multimedia home platform (MHP), for exmaple.

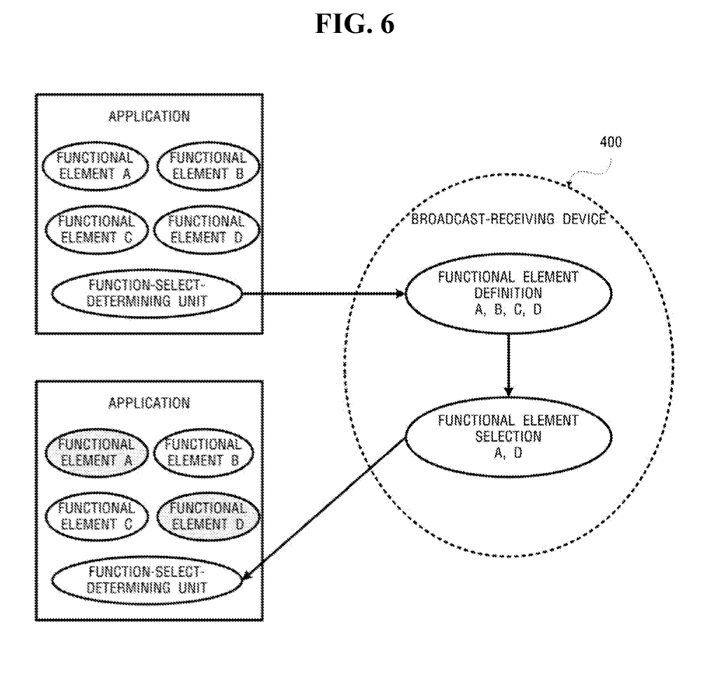

The functional-element-defining unit 420 defines a functional element including each of at least two functions of the application based on the analysis. To determine the functional element in advance, the functional-element-defining unit 420 should receive the result of determining which functional element is activated or not activated from the application, and defines the functional element by referring to the received determining result, which is conceptually depicted in FIG. 6.

FIG. 6 depicts a process of selecting the function of an application appropriate to a broadcast-receiving device according to an exemplary embodiment of the present invention.

It is assumed that the application of the transmitter has four functional elements A, B, C, and D, and has a function-selection-determining unit that selects at least one of the four functional elements. When the application is transmitted to an application-executing apparatus 400 by the application-transmitting unit 320, the application-executing apparatus 400 can define the executable functional element in advance. The application-executing apparatus 400 can select one of the four functional elements, and also two, three, or all of the four functional elements. FIG. 6 shows that the application-executing apparatus 400 selects two functional elements A and D in order to define the functional element by referring to the function-selection-determining unit of the application. The application-executing apparatus 400 sends information on the defined functional elements A and D to the application. The application activates two functional elements A and D of the four functional elements by referring to the defined functional elements A and D.

The function-selection-determining unit 430 of the application-executing apparatus 400 selects and activates the functional elements A and D by referring to the functional-element-defining unit 420 or the application.

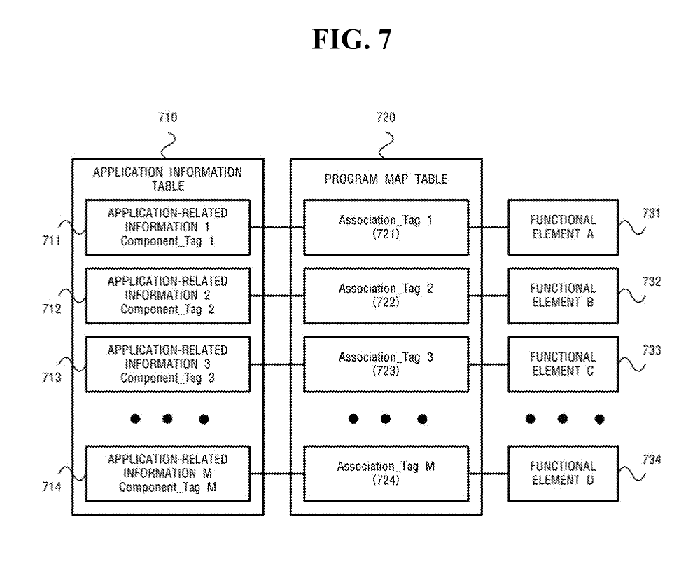

The executing unit 440 executes the selected functional elements A and D, which includes a component-tag-obtaining unit 441 that obtains component-tag information related with the application by analyzing the AIT or the XAIT, an association-tag-obtaining unit 442 that obtains association-tag information included in a program map table of the stream including the application, and an application-executing unit 443 that receives the application by comparing the component-tag information and the association-tag information. The executing process will be described in detail with reference to FIG. 7.

FIG. 7 depicts a process of executing an application by comparing component tag information and association tag information.

Referring to FIG. 7, application information 711 through 714 can be transmitted via an application information table 710. The application information 710 includes the component-tag for identifying a basic service component that transmits the application. The identified component is a stream that transmits information of the object carousel.

A program map table within the stream includes the association-tag 721 through 724 that discloses carousel information. Functional elements 731 through 734 can be obtained from the stream linked to the association-tag 721 through 724. Therefore, it is possible to execute the selected functional elements using the component-tag, which is carousel information included in the application information, and the association-tag, which is carousel information included in the program map table of the stream including the application.

The application-executing apparatus 400 can be included in the data broadcast-receiving device, and can select and execute the appropriate functional element even if one application having a plurality of functional elements is received. The application-executing apparatus 400 may be configured to select and execute the appropriate functional element by communicating with the data-broadcast-receiving device via a predetermined interface.

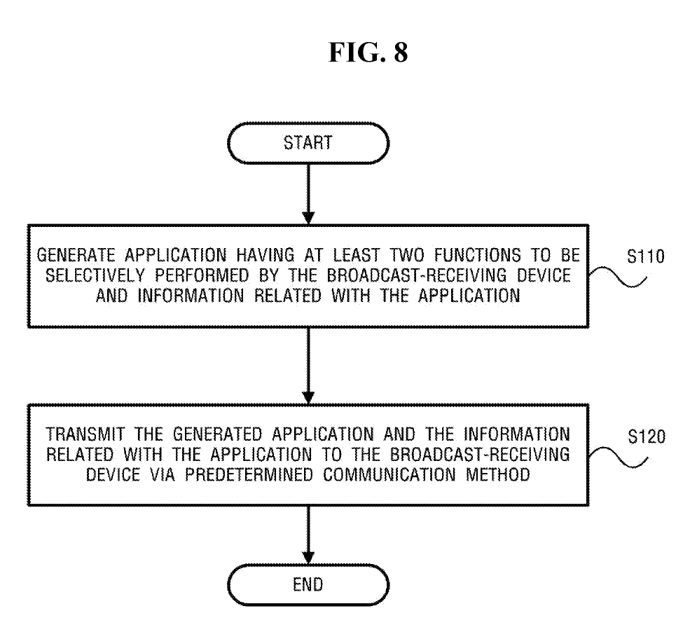

FIG. 8 is a flow chart of a method of configuring the function of an application appropriate to a broadcast-receiving device according to an exemplary embodiment of the present invention.

The application-generating unit 310 generates an application having at least two functions to be selectively performed by the broadcast-receiving device and information related with the application (S110).

The application-transmitting unit 320 transmits the generated application and the information related with the application to the broadcast-receiving device via a predetermined communication method (S120). In this case, the application determines which function is activated among at least two functions, and provides the determining result to the broadcast-receiving device.

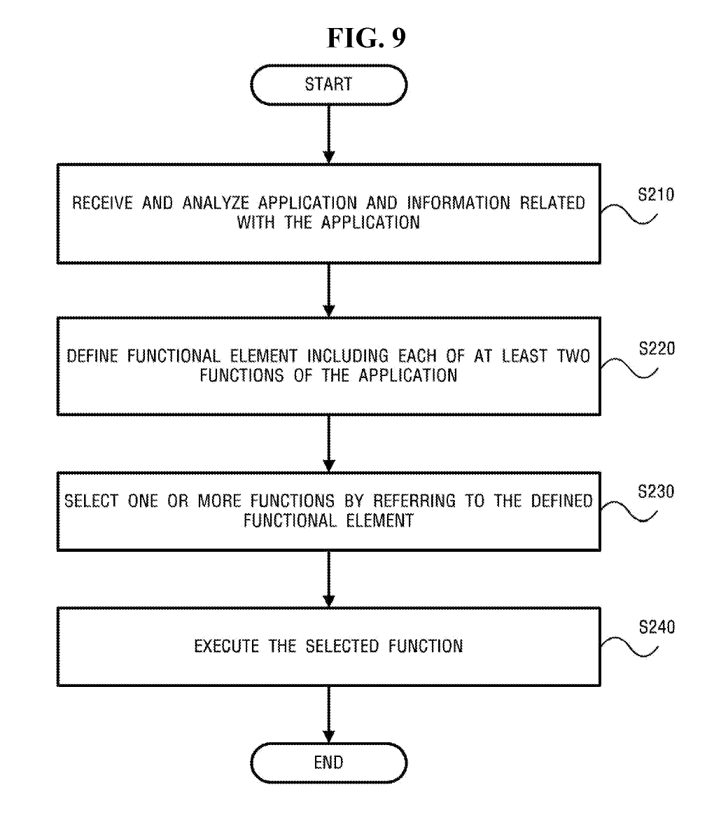

FIG. 9 is a flow chart of a method of executing the function of an application appropriate to a broadcast-receiving device according to an exemplary embodiment of the present invention.

The application-analyzing unit 410 receives and analyzes an application and information related with the application using a predetermined communication method (S210). The functional-element-defining unit defines a functional element including each of at least two functions of the application based on the analysis (S220).

The function-selecting unit 430 selects one or more functions among the two or more functions (S230). The executing unit executes the selected function (S240), which will be described in detail below.

Component-tag information related with the application is obtained by analyzing the AIT or the XAIT. Association-tag information included in the program map table of the stream including the application is obtained. Then, the application is executed by comparing the component-tag information and the association-tag information.

It should be understood that the scope and spirit of the present invention also include a recording medium recording a machine-readable program necessary for carrying out the method for configuring and executing an application appropriate to a broadcast-receiving device described in the above exemplary embodiments of the present invention.

As described above, the apparatus and method for configuring and executing an application appropriate to a broadcast-receiving device according to the present invention may produce one or more of the effects described below.

A broadcast-receiving device that exists in a network provides information on the broadcast-receiving device when executing an application, and therefore the application can select which function is activated or not activated among several functional elements included in the application.

The application can provide only the function appropriate to the broadcast-receiving device to a user, and therefore service providers can use a single application for all broadcast-receiving devices without producing a plurality of applications, thereby enabling service providers to efficiently develop applications.

The function provided by the broadcast-receiving device is only selectively operated, thereby reducing waste of resources and preventing a program error.

Although exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for configuring a function of an application appropriate to a broadcast-receiving device, the apparatus comprising:
an application-generating unit that generates an application having at least two functions to be selectively performed by the broadcast-receiving device and information related with the application; and
an application-transmitting unit that transmits the generated application and the information related with the application to the broadcast-receiving device via a predetermined communication method,
wherein the application determines which function is activated among the at least two functions using information for the broadcast-receiving device, and provides the determined result to the broadcast-receiving device.

2. The apparatus of claim 1, wherein the information related with the application is recorded in an application information table (AIT) or an extended application information table (XAIT), and transmitted to the broadcast-receiving device.

3. The apparatus of claim 2, wherein the AIT or the XAIT includes information on the broadcast-receiving device where the application can be executed.

4. The apparatus of claim 1, wherein the communication method includes data broadcast standards provided by open cable application platform (OCAP), advanced common application platform (ACAP), or multimedia home platform (MHP).

5. An apparatus for executing a function of an application appropriate to a broadcast-receiving device, the apparatus comprising:
an application-analyzing unit that receives and analyzes an application and information related with the application using a predetermined communication method;
a functional-element-defining unit that defines a functional element for each of at least two functions of the application based on the analysis;
a function-selecting unit that selects one or more functions among the two or more functions, referring to the functional element; and
an executing unit that executes the selected function.

6. The apparatus of claim 5, wherein the information related with the application is recorded in an application information table (AIT) or an extended application information table (XAIT), and transmitted to the broadcast-receiving device, and the AIT and the XAIT records information on the broadcast-receiving device where the application can be executed.

7. The apparatus of claim 6, wherein the executing unit comprises:
a component-tag-obtaining unit that obtains component-tag information related with the application by analyzing the AIT or the XAIT;
an association-tag-obtaining unit that obtains association-tag information included in a program map table of a stream including the application; and
an application-executing unit that executes the application by comparing the component-tag information and the association-tag information.

8. The apparatus of claim 5, wherein the functional-element-defining unit receives a result of determining which functional element is activated or not activated from the application, and defines the functional element by referring to the received determined result.

9. The apparatus of claim 5, wherein the application determines which function is activated among the at least two functions by referring to the functional-element-defining unit, and the function-selecting unit selects one or more functions by receiving the determined result of the application.

10. The apparatus of claim 5, wherein the communication method includes data broadcast standards provided by open cable application platform (OCAP), advanced common application platform (ACAP), or multimedia home platform (MHP).

11. A method of configuring the function of an application appropriate to a broadcast-receiving device, the method comprising:
generating an application having at least two functions to be selectively performed by the broadcast-receiving device and information related with the application; and
transmitting the generated application and the information related with the application to the broadcast-receiving device via a predetermined communication method,
wherein the application determines which function is activated among the at least two functions using information for the broadcast-receiving device, and provides the determined result to the broadcast-receiving device.

12. The method of claim 11, wherein the information related with the application is recorded in an application information table (AIT) or an extended application information table (XAIT), and transmitted to the broadcast-receiving device.

13. The method of claim 12, wherein the AIT or the XAIT includes information on the broadcast-receiving device where the application can be executed.

14. The method of claim 11, wherein the communication method includes data broadcast standards provided by open cable application platform (OCAP), advanced common application platform (ACAP), or multimedia home platform (MHP).

15. A method for executing the function of an application appropriate to a broadcast-receiving device, the method comprising:
receiving and analyzing an application and information related with the application using a predetermined communication method;
defining a functional element for each of at least two functions of the application based on the analysis;
selecting one or more functions among the two or more functions, referring to the functional element; and
executing the selected function.

16. The method of claim 15, wherein the information related with the application is recorded in an application information table (AIT) or an extended application information table (XAIT), and transmitted to the broadcast-receiving device and the AIT and the XAIT records information on the broadcast-receiving device where the application can be executed.

17. The method of claim 16, wherein the executing comprises:
obtaining component-tag information related with the application by analyzing the AIT or the XAIT;
obtaining association-tag information included in a program map table of a stream including the application; and
executing the application by comparing the component-tag information and the association-tag information.

18. The method of claim 15, wherein the defining receives a result of determining which functional element is activated or not activated from the application, and defines the functional element by referring to the received determining result.

19. The method of claim 15, wherein the application determines which function is activated among the at least two functions by referring to the functional-element-defining unit and the selecting selects one or more functions by receiving the determined result of the application.

20. The method of claim 15, wherein the communication method includes data broadcast standards provided by open cable application platform (OCAP), advanced common application platform (ACAP), or multimedia home platform (MHP).
